(19) United States
(12) Patent Application Publication
(10) Pub. No.: US 2004/0080478 A1
(43) Pub. Date: Apr. 29, 2004

(54) Image display apparatus

(75) Inventor: Hajime Akimoto, Ome (JP)

Correspondence Address: Stanley P. Fisher, Reed Smith LLP, Suite 1400, 3110 Fairview Park Drive, Falls Church, VA, 22042-4503, US

(73) Assignee: Hitachi, Ltd.

(21) Appl. No.: 10/465,568

(22) Filed: Jun. 20, 2003

(30) Foreign Application Priority Data
Oct. 29, 2002 (JP) P2002-313621

(51) Int. Cl. G09G 3/36

(52) U.S. Cl. 345/87; 345/103

(57) ABSTRACT

The present invention relates to a memory-incorporating image display apparatus which can increase the number of pixels and reduce the area of a peripheral area. A plurality of the image display apparatuses of the present invention have a frame memory of construction in which memory blocks having memory cells and voltage amplification means are connected in series.

### BACKGROUND OF THE INVENTION

1. Field of the Invention

The present invention relates to an image display apparatus which can easily increase the number of pixels. More specifically, the present invention relates to an image display apparatus which can reduce its cost.

2. Description of the Related Art

Two prior arts will be described below using FIGS. 13, 14 and 15.

FIG. 13 is a block diagram of a liquid crystal display device using a first prior art. A pixel 211 having a liquid crystal capacitance 213 and a pixel TFT (Thin-Film-Transistor) 212 is arranged in a display area 207 in shape of a matrix. The pixel 211 is connected via a gate line 210 and a signal line 209 to a gate scanning circuit 208 and a DA converter 206. The DA converter 206 is connected via a data line 205 to a frame memory 203 and a data input part 202. The frame memory 203 is scanned by a frame memory scanning circuit 204. The circuit is constructed on an SiO₂ substrate 201 using a poly crystal Si-TFT.

The operation of the first prior art will be described below. Displayed data written from the data input part 202 to the frame memory 203 is sequentially outputted to the data line 205 as the frame memory 203 is scanned by the frame memory scanning circuit 204. The frame memory 203 inputs the displayed data to the DA converter 206 upon refresh of the displayed data. The DA converter 206 outputs a display voltage signal, corresponding to the displayed data to the signal line 209. The gate scanning circuit 208 is synchronized with the frame memory scanning circuit 204 to scan the pixel 211 via the gate line 210. The pixel TFT 212 of the pixel 211 selected by this is opened and closed to write the display voltage signal to the selected liquid crystal capacitance 213. The liquid crystal display device can continue display when writing of the displayed data is stopped from outside.

The construction of the frame memory 203 in the first prior art will be described in greater detail using FIG. 14. FIG. 14 is a block diagram of the frame memory in the first prior art. Each memory cell 221 has a 1 transistor +1 capacitance construction having a memory capacitance 223 and a memory TFT 222. The memory TFT 222 is connected via a word line 224 to the frame memory scanning circuit 204. The memory cell 221 is connected in parallel to the data line 205. One-side end of the data line 205 is connected to a sense amplifier 225. Such prior art is described in detail in Japanese Patent Application Laid-Open No. Hei 11-85065.

The other prior art will be described using FIG. 15. The construction of a liquid crystal display device using a second prior art is basically the same as the construction disclosed in the description of the above-mentioned first prior art except for the construction of the frame memory. The construction of the frame memory 203 of the liquid crystal display device using the second prior art will be described here using FIG. 15. FIG. 15 is a block diagram of the frame memory in the second prior art. Each memory cell 231 has a 3-transistor construction having an output TFT 235, a memory TFT 232 and a selection TFT 236. The gate capacitance of the output TFT 235 serves as a storage capacitance. The memory TFT 232 is connected via a first word line 234 to a frame memory scanning circuit 238, and the selection TFT 236 is connected via a second word line 237 thereto. The memory cell 231 is connected in parallel to the data line 205. When using the second prior art, the sense amplifier as in the case of using the first prior art is unnecessary. This is because there is used a gain cell construction having the output TFT 235 for output amplification in the memory cell 231 is employed. Such prior art is described in detail in Japanese Patent Application Laid-Open No. 2002-82656.

### SUMMARY OF THE INVENTION

As the direction of the future flat displays, increase in the number of pixels and reduction in the area of a peripheral area other than a display area can be considered. In the extension of the prior arts, it is difficult to satisfy these two problems at the same time. This will be described below.

In the first prior art described using FIGS. 13 and 14, the displayed data read from the frame memory is inputted as a signal electric-carrier to the data line. In increase in the number of pixels, the number of memory cells connected to the data line is increased so that the value of the data line capacitance is abruptly larger. The change amount of a signal voltage produced by the signal electric-carrier inputted to the data line is very small. The sense amplifier must amplify the signal voltage at a lower S/N. Initially, this can be solved by making the sense amplifier circuit complicated and increasing the power consumption. Sooner or later, this will be limited by the number of memory cells to limit increase in the number of pixels.

In the second prior art described using FIG. 15, the displayed data is buffered by the output TFT when being read from the memory cell to the data line. Increase in the data line capacitance with increase in the number of pixels is not a direct problem. The construction of the memory cell of the second prior art is essentially complicated. The occupied area of the frame memory is abruptly increased by increase in the frame memory capacitance with increase in the number of pixels. At increase in the number of pixels, the area of the peripheral area other than the display area is significantly increased. The loads of design of equipment equipped with a flat display and the cost are large. The second prior art system is not preferable.

The above problems can be solved by an image display apparatus having a display part provided with a plurality of pixels arranged in shape of a matrix, display signal input means inputting a display signal to the pixels, display signal generation means generating the display signal from digital displayed data, and digital displayed data holding means holding the digital displayed data, wherein the digital displayed data holding means has a memory block having a plurality of memory cells which can hold 1-bit data, a memory cell selection circuit for selecting the memory cell, a block data line connected in parallel to the plurality of memory cells, and data voltage amplification means connected to the block data line, and the respective block data lines in a plurality of the memory blocks are connected in series via a block connection switch.

### BRIEF DESCRIPTION OF THE DRAWINGS

FIG. 1 is an overall block diagram according to a first embodiment;

FIG. 2 is a block diagram of a frame memory according to the first embodiment;

FIG. 3 is a block diagram of the periphery of a signal amplification circuit according to the first embodiment;

FIG. 4 is a reading operation signal diagram of the periphery of the signal amplification circuit according to the first embodiment;

FIG. 5 is a cross-sectional construction diagram of a 1-bit cell according to of the first embodiment;

FIG. 6 is a cross-sectional construction diagram of a pixel according to the first embodiment;

FIG. 7 is a block diagram of a frame memory according to a second embodiment;

FIG. 8 is a block diagram of the periphery of a signal amplification circuit according to the second embodiment;

FIG. 9 is a reading operation signal diagram of the periphery of the signal amplification circuit according to the second embodiment;

FIG. 10 is an overall block diagram according to a third embodiment;

FIG. 11 is an overall block diagram according to a fourth embodiment;

FIG. 12 is an overall block diagram according to a fifth embodiment;

FIG. 13 is a block diagram of a liquid crystal display device using a first prior art;

FIG. 14 is a block diagram of a frame memory according to the first prior art; and

FIG. 15 is a block diagram of the frame memory according to a second prior art.

### DETAILED DESCRIPTION OF THE PREFERRED EMBODIMENTS

The above objects and other objects of the present invention will be apparent from the following detailed description and the attached claims with reference to the accompanying drawings. The same reference numerals in the accompanying drawings-denote the same or similar parts.

(First Embodiment)

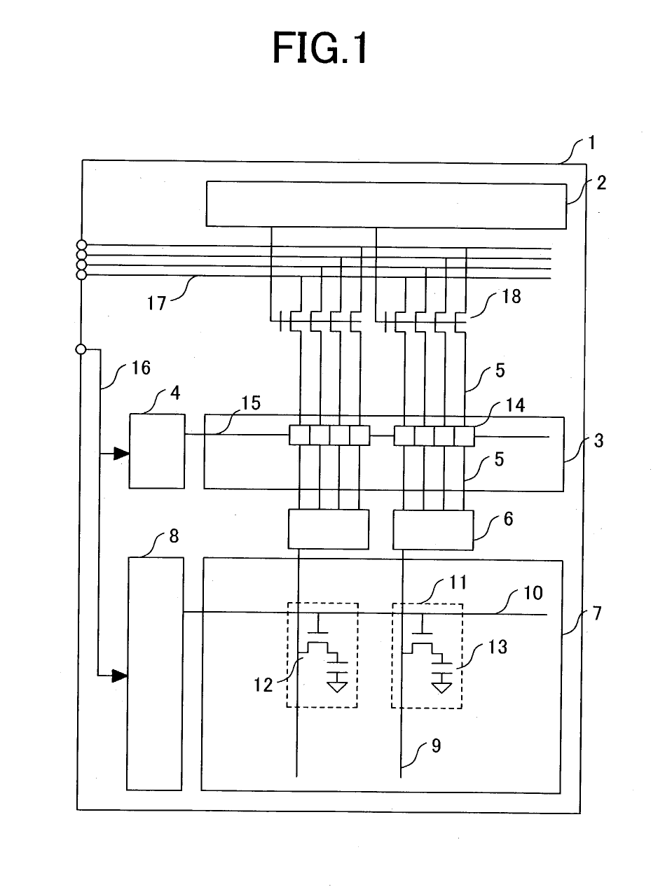

A first embodiment of the present invention will be described below using FIGS. 1 to 6. First, the overall construction of this embodiment will be described using FIG. 1.

FIG. 1 is a block diagram of a liquid crystal display panel of this embodiment. For simplifying the drawing, only two pixels are illustrated here. Actually, 640×480×RGB pixels corresponding to a VGA format are provided. A pixel 11 having a liquid crystal capacitance 13 as an optical display object and a pixel TFT (Thin-Film-Transistor) 12 as a writing switch is arranged in a display part 7 in shape of a matrix. The gate of the pixel TFT 12 is connected via a gate line 10 to a gate scanning circuit 8. One-side end of the pixel TFT 12 is connected via a signal line 9 to a DA converter 6. The DA converter 6 is connected via data lines 5 to a frame memory 3. The other-side ends of the data lines 5 are connected via sample hold switches 18 to displayed data input lines 17. The sample hold switches 18 are driven by a sample hold switch scanning circuit 2. Memory cells 14 are arranged in the frame memory 3 in shape of a matrix. In FIG. 1, only one row of the memory cells 14 for two columns of the pixels is illustrated for simplifying the drawing. Actually, 480 rows of the memory cells 14 corresponding to the rows of the pixels are provided in the frame memory 3. As shown in FIG. 1, the memory cells 14 in the same row are connected via a word line 15 to a word line scanning circuit 4. An identical driving clock line 6 performs inputting to the gate scanning circuit. 8 and the word line scanning circuit 4. The display part 7, the gate scanning circuit 8, the DA converter 6, the frame memory 3, the word line scanning circuit 4, the sample hold switches 8, and the sample hold switch scanning circuit 2 are provided on a glass substrate 1 using a poly crystal Si-TFT. Methods for manufacturing the poly crystal Si-TFT and the liquid crystal capacitance 13 are not largely different from the generally reported ones. The description is omitted here. As the constructions of the gate scanning circuit 8 and the sample hold switch scanning circuit 2 in this embodiment, a circuit construction generally known as a shift resistor circuit is used. The DA converter 6 can be reconstructed in the general knowledge range. The operation of this embodiment will be described.

According to the displayed data inputted from the displayed data input line 17, the sample hold switch scanning circuit 2 sequentially scans the sample hold switch 18 to write the displayed data to the data line 5. The word line scanning circuit 4 scans the memory cells 14 via the word line 15 at a predetermined timing to write the displayed data to a predetermined memory cell in the frame memory 3. The above is the writing operation to the frame memory 3.

As the word line scanning circuit 4 scans the memory cell 14 via the word line 15, the displayed data in the memory cell 14 is sequentially outputted to the data line 5. The displayed data is inputted to the DA converter 6 upon refresh of the frame memory 3. The DA converter 6 outputs a display voltage signal corresponding to the displayed data to the signal line 9. The gate scanning circuit 8 is synchronized with the word line scanning circuit 4 to scan the pixels 11 via the gate line 10. The pixel TFT 12 of the pixel 11 selected by this is opened and closed. The display voltage signal is written to the selected liquid crystal capacitance 13. This liquid crystal display device can continue display when the writing of the displayed data is stopped from outside.

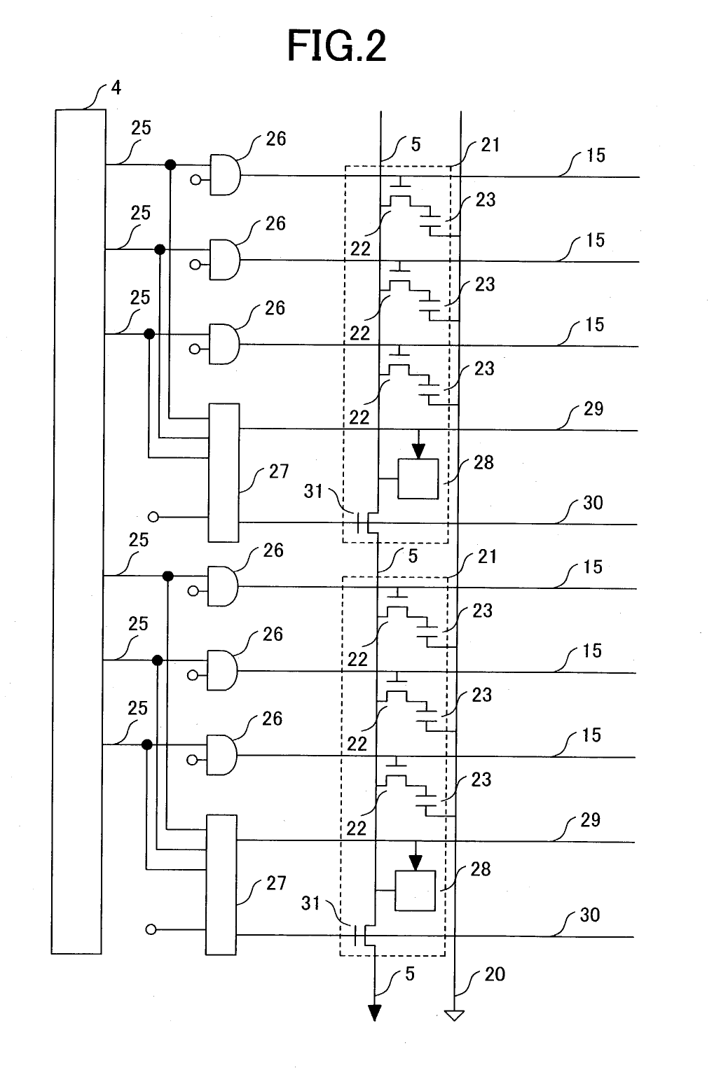

The construction of a frame memory 203 in the first embodiment will be described in greater detail using FIG. 2. FIG. 2 is a block diagram of the frame memory in the first embodiment. A plurality of 1-bit cells of 1 transistor +1 capacitance construction having a memory capacitance 23 and a memory TFT 22 are provided in each memory cell 21. The memory TFT 22 is connected to the block data line 5. The block data line 5 is further connected to signal amplification circuits 28. One-side ends thereof are interconnected via a block data line connection switch 31. Memory cell scanning lines 25 provided in the word line scanning circuit 4 are connected via AND circuits 26 for bit selection to the word lines 15. The word lines are connected to the gates of the memory TFTs 22. The memory cell scanning lines 25 are also connected via a memory cell input/output control circuit 27 to a signal amplification circuit control line 29 controlling the signal amplification circuit 28 and a block data line connection switch control line 30.

The frame memory writes the displayed data from outside to the predetermined memory capacitance 23 when the word line 15 corresponding to the predetermined memory TFT 22 and the block data line connection switch control line 30 are turned on. The word line 15 corresponding to the predetermined memory TFT 22 is turned on and the signal amplification circuit control line 29 of the corresponding memory cell 21 is turned on to activate the signal amplification circuit 28 for performing a data refresh operation. The block data line connection switch control line 30 is turned on to perform writing of the displayed data from the predetermined memory capacitance 23 to the DA converter 6 and data refresh.

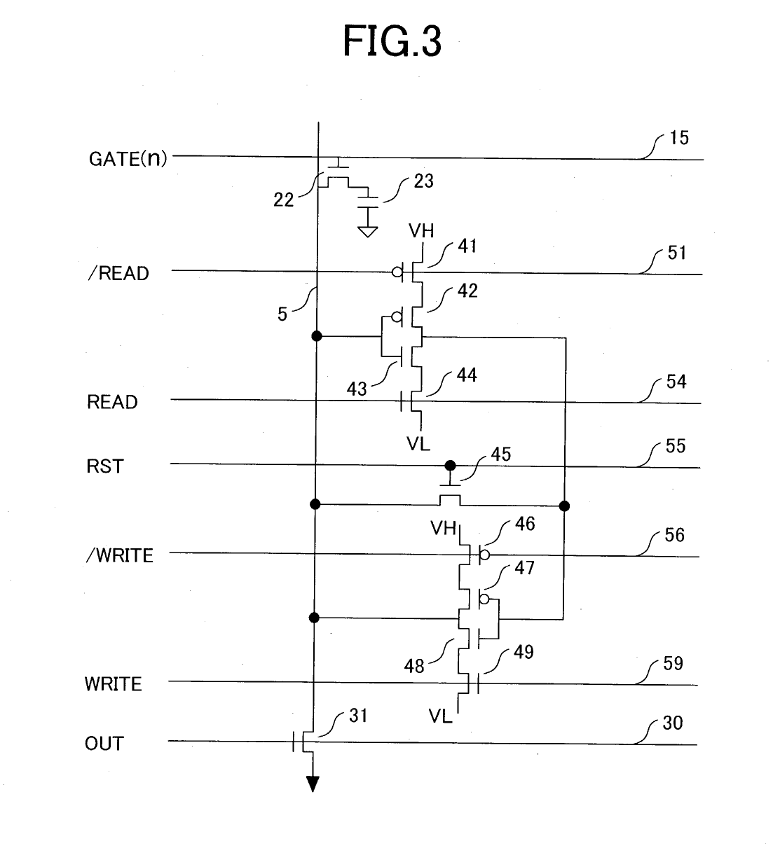

The construction of the signal amplification circuit 28 will be described using FIG. 3. FIG. 3 is a block diagram of the periphery of the signal amplification circuit 28 in the first embodiment. The block data line 5 connected to the 1-bit cell having the memory capacitance 23 and the memory TFT 22 is connected to the input of a CMOS inverter circuit with a power switch having a pMOS power switch 41, a pMOS-TFT 42, an nMOS-TFT 43 and an nMOS power switch 44. The output is connected to the input of a COMS inverter circuit with a power switch having a pMOS power switch 46, a pMOS-TFT 47, an nMOS-TFT 48 and an nMOS power switch 49. The output of the circuit is connected to the block data line 5 to construct a kind of a Flip-Flop circuit.

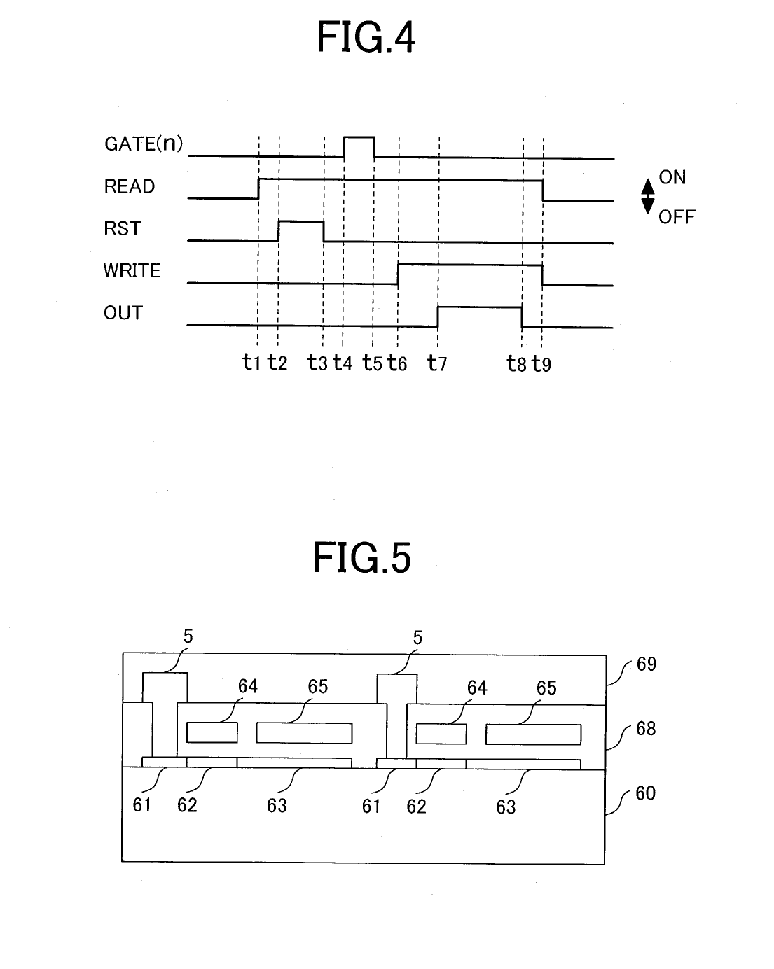

The input terminals of both the CMOS inverter circuits with a power switch are connected by a reset switch 45. The word line 15 of the nth 1-bit cell is GATE(n). A control line 51 of the pMOS power switch 41 is /READ. A control line 54 of the nMOS power switch 44 is READ. A control line 55 of the reset switch 45 is RST. A control line 56 of the pMOS power switch 46 is /WRITE. A control line 59 of the nMOS power switch 49 is WRITE. The block data line connection switch control line 30 of the memory cell is OUT. On-off operations of these will be described using FIG. 4.

FIG. 4 is a diagram showing reading operation signals of the periphery of the signal amplification circuit 28 in which the upper side indicates on and the lower side indicates off. The /READ is an inverted signal of the READ and the /WRITE is an inverted signal of the WRITE, which are omitted from the drawing. First, the READ is turned on at timing t1 to activate the CMOS inverter circuit with a power switch having the block data line 5 as an input. Then, the RST is turned on and off at timings t2, t3 to reset the input and output of the CMOS inverter circuit with a power switch to the same voltage. Thereafter, the GATE(n) is turned on and off at timings t4, t5 to read a signal electric-carrier from the 1-bit cell to the block data line 5. The capacitance of the block data line 5 is not much larger than the memory capacitance 23. The signal electric-carrier can sufficiently operate the output of the COMS inverter circuit with a power switch having the block data line 5 as an input. The WRITE is turned on at timing t6 to activate the CMOS inverter circuit with a power switch having the block data line 5 as an output so that the output of the block data line 5 is defined to High or Low. The OUT is turned on at timing t7 to transmit the output of the block data line 5 via the plurality of later block data lines 5 to the DA converter 6. The WRITE and OUT are turned off at timings t8, t9 in that order to complete reading of the 1-bit.

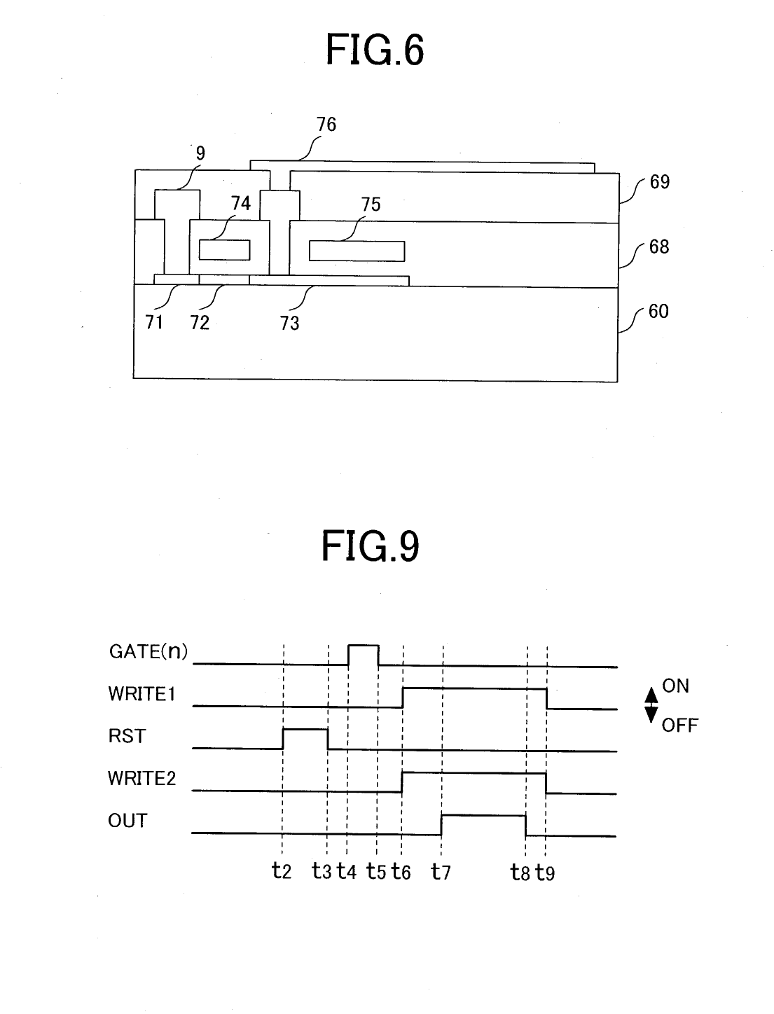

The constructions of the 1-bit cell and the pixel will be described using FIGS. 5 and 6. FIG. 5 shows a cross-sectional construction of the 1-bit cell. A poly crystal Si-TFT having a source 61, a channel 62, a drain 63 and a gate 64 is provided on a glass substrate 60 to construct the memory TFT. The source 61 is connected to the block data line 5 made of Al. A ground electrode 65 of the same construction as that of the gate 64 is provided on the drain 63 to interpose an insulating film 68, thereby constructing the memory capacitance. A protective film 69 is further deposited on the block data line 5.

FIG. 6 shows a cross-sectional construction of the pixel. A poly crystal Si-TFT having a source 71, a channel 72, a drain 73 and a gate 74 is provided on the glass substrate 60 to construct the memory TFT. The source 71 is connected to the signal line 9 made of Al. A ground electrode 75 of the same construction as that of the gate 74 is provided on the drain 73 to interpose the insulating film 68, thereby constructing a liquid crystal auxiliary capacitance in parallel with the liquid crystal capacitance. The protective film 69 is further deposited on the signal line 9. A transparent electrode of ITO (Indium-Tin-Oxide) is provided on the drain 73. A liquid crystal layer, an opposed electrode and an opposed glass substrate are further provided on the transparent electrode. Since its construction is typical, the description is omitted. The memory TFT, the pixel TFT, the memory capacitance and the liquid crystal auxiliary capacitance have the same layer construction, they can be manufactured at the same time.

In this embodiment described above, various modifications can be made within the scope without deteriorating the purpose of the present invention. For example, this embodiment uses a glass substrate as the TFT substrate. This can be changed to other transparent insulating substrates such as a silica substrate and a transparent plastic substrate.

In the description of this embodiment, the pixel size and the panel size are not consciously described. This is because the present invention is not limited to these specifications or formats. This time, the display signal has 4 bits. The gradation can be increased, for example, to 6 bits. Reversely, the gradation can be easily lowered. The number of bits can be changed in the respective colors of RGB.

In this embodiment, the respective circuits are constructed by a poly crystal Si-TFT circuit. These peripheral driving circuits or one portion thereof can also be constructed by a single crystal LSI (Large Scale Integrated circuit) to be mounted within the scope of the present invention.

The above various modifications can be basically applied in the same manner, not only in this embodiment but also in the following other embodiments.

(Second Embodiment)

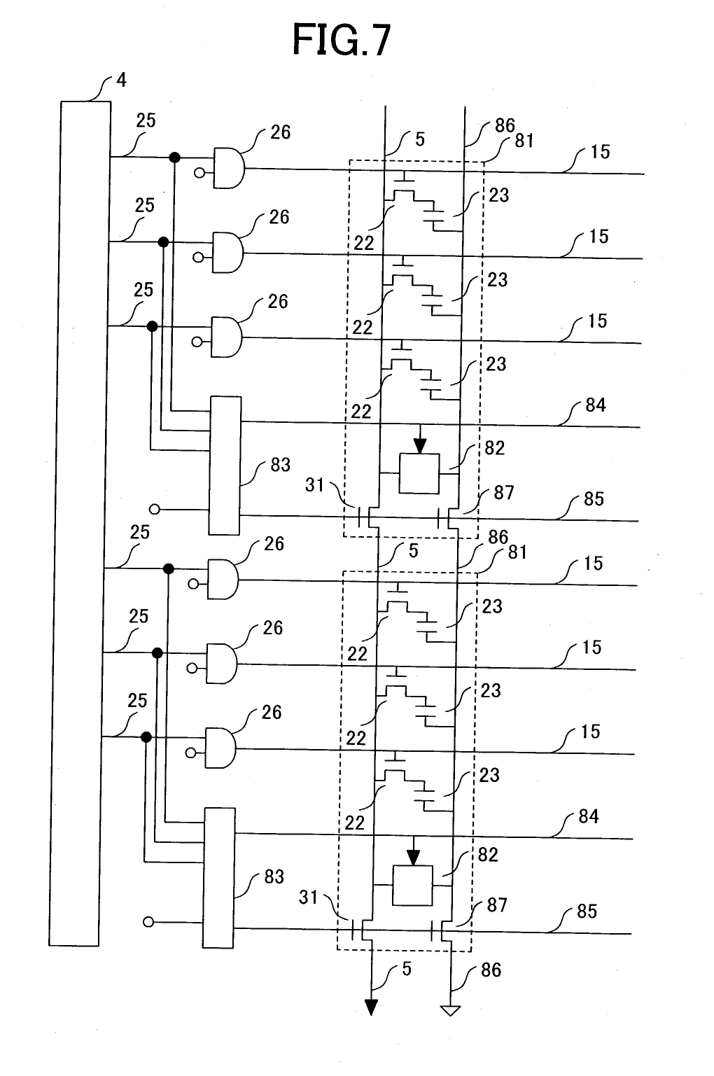

A second embodiment of the present invention will be described using FIGS. 7, 8 and 9. The overall construction and operation of the second embodiment of the present invention are the same as those of the first embodiment of the present invention except for the inner construction of the frame memory and its operation. For this reason, the frame memory as the feature of the second embodiment of the present invention will be described here.

FIG. 7 is a block diagram of a frame memory in the second embodiment. A plurality of 1-bit cells of 1 transistor +1 capacitance construction having the memory capacitance 23 and the memory TFT 22 are provided in each memory cell 81. The memory TFT 22 is connected to the block data line 5. The block data line 5 is further connected to a signal amplification circuit 82. One-side ends thereof are interconnected via the block data line connection switch 31. The memory cell scanning lines 25 provided in the word line scanning circuit 4 are connected to the word lines 15 via the AND circuits 26 for bit selection. The word lines are connected to the gates of the memory TFTs 22. The memory cell scanning lines 25 are also connected via a memory cell input/output control circuit 83 to a signal amplification circuit control line 84 controlling the signal amplification circuit 82 and a block data line connection switch control line 85. In this embodiment, one-side end of the memory capacitance 23 is connected to a second block data line 86. The second block data line 86 is also connected to the signal amplification circuit 82. One-side ends thereof are interconnected via a second block data line connection switch 87.

The frame memory writes the displayed data from outside to the predetermined memory capacitance 23 when the word line 15 corresponding to the predetermined memory TFT 22 and the block data line connection switch control line 85 are turned on. The word line 15 corresponding to the predetermined memory TFT 22 is turned on and the signal amplification circuit control line 84 of the corresponding memory cell 81 is turned on to activate the signal amplification circuit 82 for performing a data refresh operation. The block data line connection switch control line 85 is turned on to perform writing of the displayed data from the predetermined memory capacitance 23 to the DA converter 6 and data refresh. It should be noted that High and Low inverted signals are written to the block data line 5 and the second block data line 86.

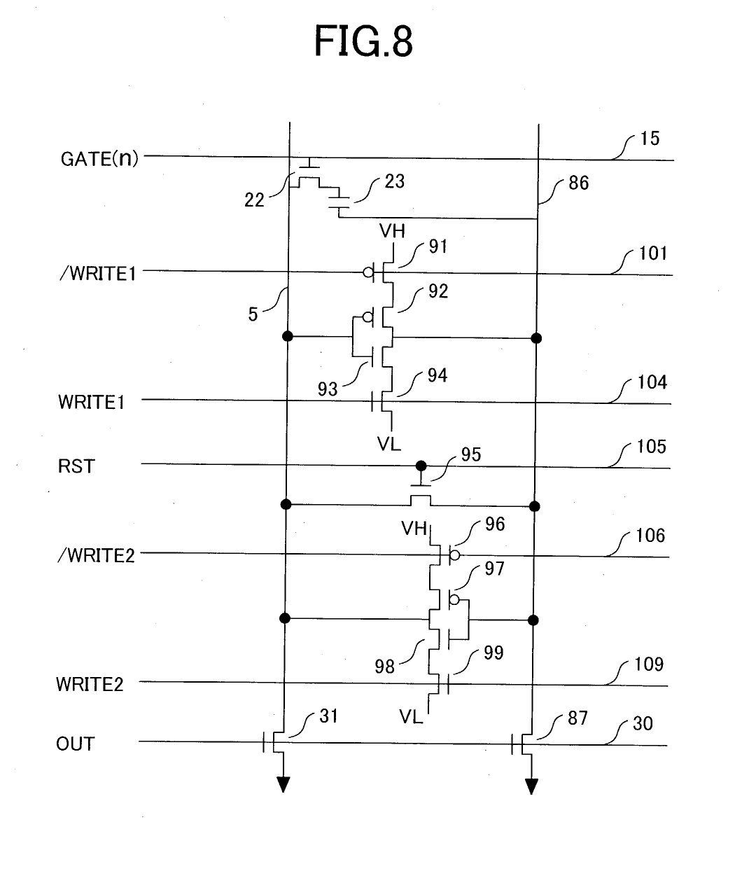

The construction of the signal amplification circuit 28 will be described using FIG. 8. FIG. 8 is a block diagram of the periphery of the signal amplification circuit 82 in the second embodiment. The block data line 5 connected to the 1-bit cell having the memory capacitance 23 and the memory TFT 22 is connected to the input of a CMOS inverter circuit with a power switch having a pMOS power switch 91, a pMOS-TFT 92, an nMOS-TFT 93 and an nMOS power switch 94. The output is connected to the second block data line 86. The second block data line 86 is connected to the input of a COMS inverter circuit with a power switch having a pMOS power switch 96, a pMOS-TFT 97, an nMOS-TFT 98 and an nMOS power switch 99. The output of the circuit is connected to the block data line 5 to construct a kind of a Flip-Flop circuit. The block data line 5 and the second block data line 86 are connected by a reset switch 95. The word line 15 of the nth 1-bit cell is GATE (n). A control line 101 of the pMOS power switch 91 is /WRITE1. A control line 104 of the nMOS power switch 94 is WRITE1. A control line 105 of the reset switch 95 is RST. A control line 106 of the pMOS power switch 96 is /WRITE2. A control line 109 of the nMOS power switch 99 is WRITE2. The block data line connection switch control line 30 of the memory cell is OUT. On-off operations of these will be described using FIG. 9.

FIG. 9 is a diagram showing reading operation signals of the periphery of the signal amplification circuit 82 in which the upper side indicates on and the lower side indicates off. The /WRITE1 is an inverted signal of the WRITE1 and the /WRITE2 is an inverted signal of the WRITE2, which are omitted from the drawing. First, the RST is turned on and off at timings t2, t3 to reset the block data line 5 and the second block data line 86 to the same voltage. Thereafter, the GATE (n) is turned on and off at timings t4, t5 to read a signal electric-carrier from the 1-bit cell to the block data line 5 and the second block data line 86. The capacitances of the block data line 5 and the second block data line 86 are not much larger than the memory capacitance 23. The signal electric-carrier can sufficiently charge the potentials of the block data line and the second block data line 86 to a reverse voltage, respectively. The WRITE1, WRITE2 are turned on at timing t6 to activate the two CMOS inverter circuits with a power switch so that the potentials of the block data line 5 and the second block data line 86 are defined to High or Low. The OUT is turned on at timing t7 to transmit the output of the block data line 5 and the second block data line 86 via the plurality of later block data lines 5 and second block data lines 86 to the DA converter 6. The WRITE and OUT are turned off at timings t8, t9 in that order to complete reading of the 1-bit. In this embodiment, only the output signal of the block data line 5 is used for inputting of the DA converter 6. A DA converter having a differential input can be introduced to use both the outputs of the block data line 5 and the second block data line 86.

In this embodiment, the S/N of a signal inputted to the signal amplification circuit 82 can be higher to use a differential signal. The number of 1-bit cells which can be arranged in one memory cell can be increased. It is possible to provide the image display apparatus in which the occupied area of the frame memory can be smaller, the degree of freedom of design can be larger, and its cost can be reduced.

(Third Embodiment)

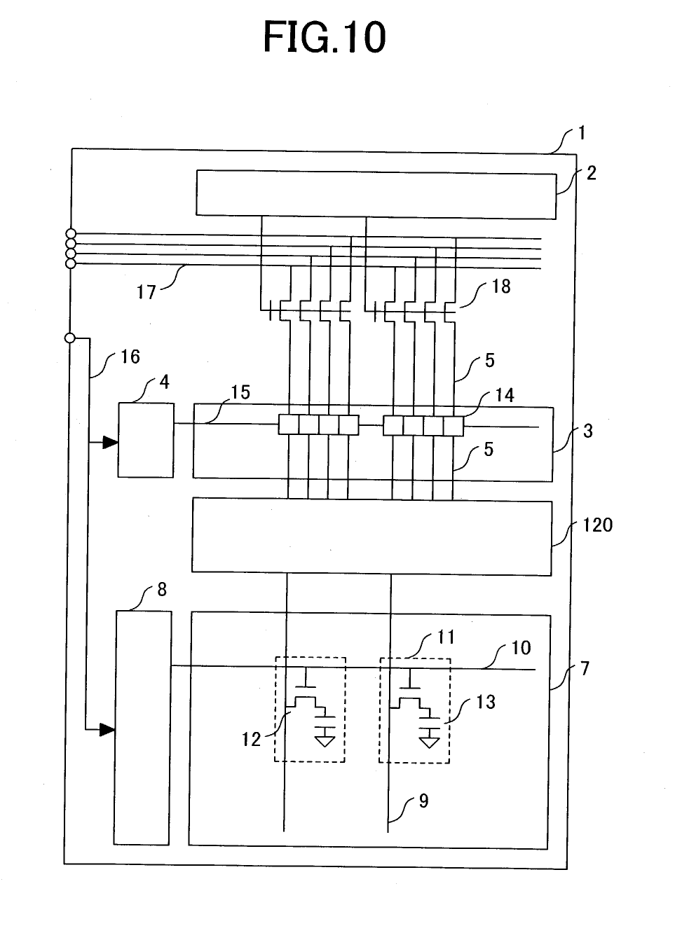

A third embodiment of the present invention will be described using FIG. 10. FIG. 10 shows an overall block diagram of the third embodiment of the present invention. The difference between this embodiment and the first embodiment is that a DA converter 120 can be realized by mounting a single crystal Si-LSI chip, not the poly crystal Si-TFT. Since other constructions and operation are the same as those of the first embodiment, the description is omitted.

In this embodiment, the single crystal Si-LSI chip is used for the DA converter 120. The high-accuracy electronic circuit can be easily mounted. The 8-bit DA converter 120 can be used. The mounting area of the terminal connection part is necessary. When using a DA converter having the smaller number of bits, mounting of the single crystal Si-LSI chip is disadvantageous in area.

(Fourth Embodiment)

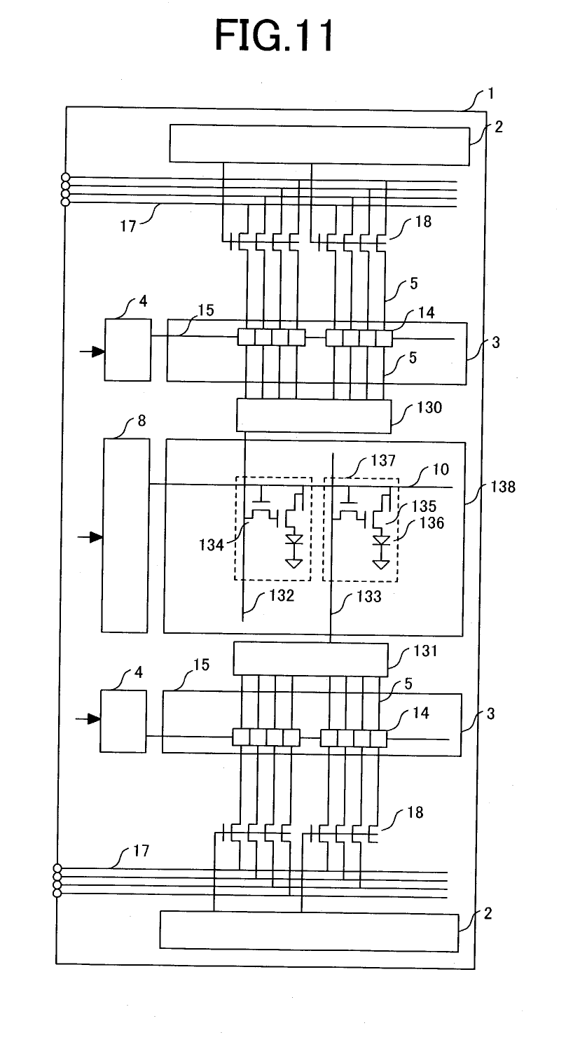

A fourth embodiment of the present invention will be described using FIG. 11. FIG. 11 shows an overall block diagram of the fourth embodiment of the present invention. The differences between this embodiment and the first embodiment are that a pixel 137 in a display area 138 displays an image by an organic EL (OLED: Organic LED) illumination, not by a liquid crystal, and that signal lines 132, 133 are wired vertically for each column so that inputting of a signal voltage is performed from the upper and lower sides of the display area 7 for each column. Since other constructions and operation are the same as those of the first embodiment, the description is omitted.

The pixel 137 has a pixel TFT 134, an organic EL device 136 and an organic EL device driving TFT 135. A driving current controlled by a signal voltage written to the gate capacitance of the organic EL device driving TFT 135 drives the organic EL device 136. This embodiment realizes an emissive display. Since the back light is unnecessary, it can be thinner than a liquid crystal display. The organic EL device used here is of generally known construction. For its construction, reference can be made to Japanese Patent Application Laid-Open No. 2001-159878 as an example.

In this embodiment, the pixel has, every one column, DA converters 130, 131 corresponding to the upper and lower sides thereof and the frame memory 3. In this embodiment, one column of the frame memory can be arranged at a pitch for two columns of the pixels. The 8-bit frame memory can be easily laid out. Since the frame memory can be distributed, only one side of the pixel peripheral circuit area can be prevented.

(Fifth Embodiment)

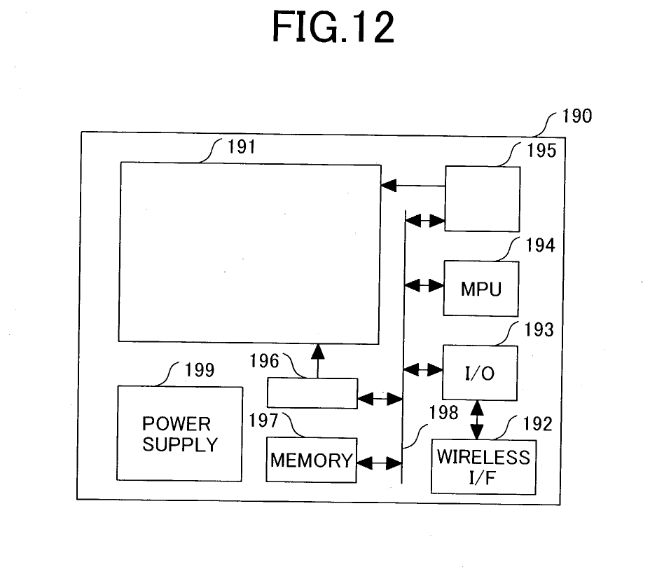

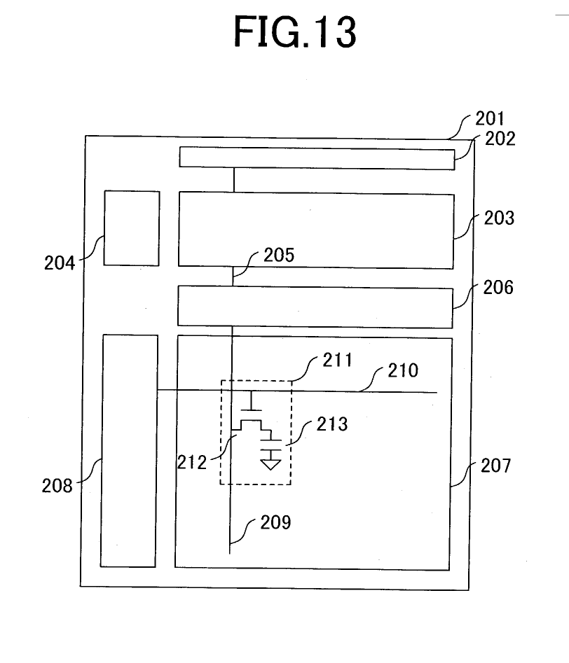

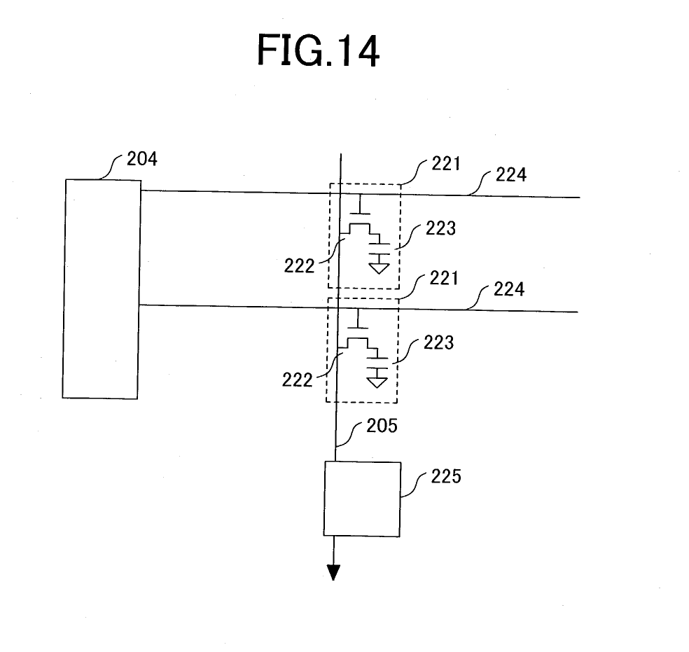

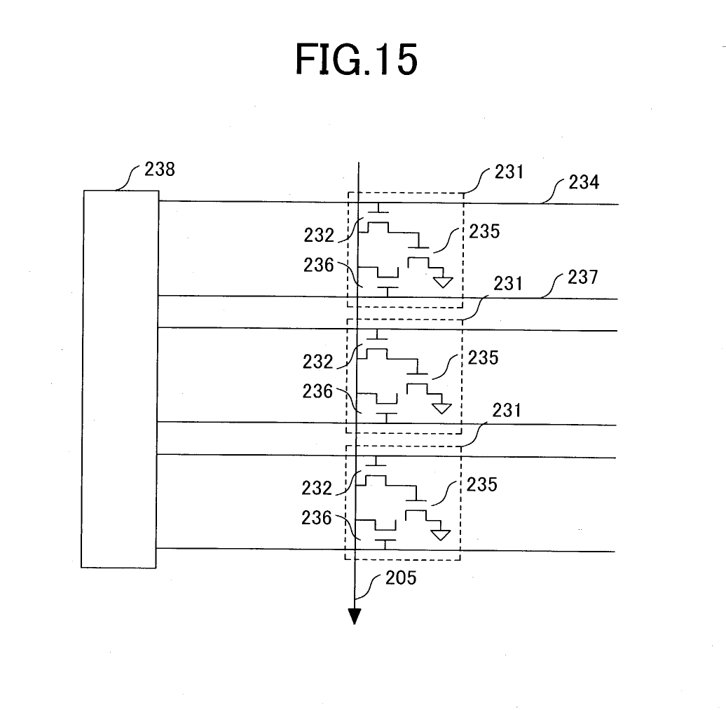

A fifth embodiment of the present invention will be described below using FIG. 12. FIG. 12 is a block diagram of an image display terminal device (PDA: Personal Digital Assistant) 190 of the fifth embodiment.

To a wireless interface (I/F) circuit 192 is inputted compressed image data as wireless data based on bluetooth standards from outside. The output of the wireless I/F circuit 192 is connected to a data bus 198 via an I/O (Input/Output) circuit 193. The data bus 198 is also connected to a microprocessor unit (MPU) 194, a display panel controller 196, and a frame memory 197. The output of the display panel controller 196 is inputted to a liquid crystal display panel 191. The image display terminal device 190 is provided with a power supply 199. The liquid crystal display panel 191 has the same construction and operation as those of the above-described first embodiment. The description of its inner construction and operation are omitted here.

The operation of the fifth embodiment will be described below. First, the wireless I/F circuit 192 fetches image data compressed according to a command from outside, and then, transfers the image data via the I/O circuit 193 to the microprocessor unit 194 and the frame memory 197. The microprocessor unit 194 receives a command operation from a user to drive the entire image display terminal device 190 when needed, and performs decode, signal-processing and information display of the compressed image data. The signal-processed image data is temporarily stored in the frame memory 197.

When the microprocessor unit 194 provides a display command, the image data is inputted from the frame memory 197 via the display panel controller 196 to the liquid crystal display panel 191 according to the command. The liquid crystal display panel 191 displays the inputted image data in real time. The display panel controller 196 outputs a predetermined timing pulse necessary for displaying an image at the same time. The power supply 199 includes a secondary battery and supplies a power driving the entire image display terminal device 100. The microprocessor unit 194 provides a necessary command to the image display terminal device 190. While being brought into the power conservation mode to stop inputting of the image data to the liquid crystal display panel 191, the microprocessor unit 194 makes use of the frame memory provided in the liquid crystal display panel 191. It can continue to display a still image only by giving the necessary predetermined timing pulse and supply voltage to the liquid crystal display panel 191. When the liquid crystal display panel 191 is driven in a reflection mode, the power consumption of the back light can be reduced. This embodiment can provide the image display terminal device 190 which can display a still image by very low power consumption.

In this embodiment, as the image display device, the liquid crystal display panel described in the first embodiment is used. It is apparent that various display panels as described in the other embodiments of the present invention can be used.

As is apparent from the above-described preferred embodiments of the present invention, the present invention can provide the image display apparatus which can increase the number of pixels and reduce the area of the peripheral area other than the display area.

What is claimed is:

1. An image display apparatus having a display part provided with a plurality of pixels arranged in shape of a matrix, display signal input means inputting a display signal to the pixels, display signal generation means generating said display signal from digital displayed data, and digital displayed data holding means holding said digital displayed data, wherein the digital displayed data holding means has a memory block having a plurality of memory cells which can hold 1-bit data, a memory cell selection circuit for selecting the memory cell, a block data line connected in parallel to the plurality of memory cells, and data voltage amplification means connected to the block data line, and the respective block data lines in a plurality of the memory blocks are connected in series via a block connection switch.

2. The image display apparatus according to claim 1, wherein said memory cell has at least a switch transistor selected from said memory cell selection circuit, and a memory cell capacitance for holding 1-bit data as an electric-carrier for a predetermined period.

3. The image display apparatus according to claim 1, wherein said data voltage amplification means has at least an inverter circuit selectively activated from said memory cell selection circuit.

4. The image display apparatus according to claim 1, wherein said pixel performs display using a luminescence phenomenon in an organic matter.

5. The image display apparatus according to claim 1, wherein said pixel performs display using an optical characteristic modulation effect of a liquid crystal of an electric field.

6. The image display apparatus according to claim 2, wherein said pixel has a pixel capacitance for storing a display signal, and the pixel capacitance has the same electrode layer construction as that of said memory cell capacitance.

7. The image display apparatus according to claim 1, wherein said display signal generation means is a DA converter generating an analog display signal from said digital displayed data of n-bits.

8. The image display apparatus according to claim 7, wherein n columns of said memory blocks are arranged corresponding to one column of the pixels.

9. The image display apparatus according to claim 7, wherein with k as a natural number, n/k columns of said memory blocks are arranged corresponding to one column of the pixels.

10. The image display apparatus according to claim 1, wherein said memory cell selection circuit and said display signal input means have a construction driven by the same basic clock pulse.

11. The image display apparatus according to claim 1, wherein with m as a natural number, said memory cell selection circuit and said display signal input means have a construction driven by a basic clock pulse having an m-times or 1/m-times frequency.

12. The image display apparatus according to claim 1, wherein said pixel, said display signal generation means and said digital displayed data holding means are constructed using a poly crystal Si-TFT.

13. The image display apparatus according to claim 1, wherein said pixel and said digital displayed data holding means are constructed using a poly crystal Si-TFT, and said display signal generation means is constructed using a single crystal Si-LSI.

14. The image display apparatus according to claim 1, wherein said block data lines are provided in twos in each of said memory cells.

15. An image display apparatus having a display part provided with a plurality of pixels arranged in shape of a matrix, display signal input means inputting a display signal to the pixels, display signal generation means generating said display signal from digital displayed data, and digital displayed data holding means holding said digital displayed data, wherein the digital displayed data holding means has, with j as a natural number, a plurality of memory blocks connected in series which can hold j-bit data, as a unit, and the memory block can hold a plurality of pieces of bit data and is constructed as a gain cell having data voltage amplification means.

16. An image display apparatus having a display part provided with a plurality of pixels arranged in shape of a matrix, display signal input means inputting a display signal to the pixels, display signal generation means generating said display signal from digital displayed data, and a frame memory holding said digital displayed data, wherein the frame memory has a memory block having a plurality of memory cells which can hold 1-bit data, a memory cell selection circuit for selecting the memory cell, a block data line connected in parallel to the plurality of memory cells, and data voltage amplification means connected to the block data line, and the respective block data lines in a plurality of the memory blocks are connected in series via a block connection switch.

17. An image display apparatus having a display part provided with a plurality of pixels arranged in shape of a matrix, display signal input means inputting a display signal to the pixels, digital signal processing means generating second digital displayed data by signal-processing first digital displayed data, display signal generation means generating said display signal from the second digital displayed data, and digital displayed data holding means holding said second digital displayed data, wherein the digital displayed data holding means has a memory block having a plurality of memory cells which can hold 1-bit data, a memory cell selection circuit for selecting the memory cell, a block data line connected in parallel to the plurality of memory cells, and data voltage amplification means connected to the block data line, and the respective block data lines in a plurality of the memory blocks are connected in series via a block connection switch.
